(19) United States
(12) Patent Application Publication
(10) Pub. No.: US 2016/0079781 A1
(43) Pub. Date: Mar. 17, 2016

(54) KEY RING ATTACHABLE MOBILE PHONE POWER AND CONTROL DEVICE

(71) Applicant: GO DEVICES LIMITED, Kowloon (HK)

(72) Inventors: Polydoros Kyriakoulis, San Francisco, CA (US); Aristotelis Barakos, Athens (GR); Mark Brinkerhoff, San Jose, CA (US); Eric Aldenbrook, Cupertino, CA (US); Thomas Geraty, San Jose, CA (US); George William Melcer, Oakland, CA (US); Walter N. Maclay, Sunnyvale, CA (US); Stuart Tyrrell, Los Altos, CA (US)

(73) Assignee: GO DEVICES LIMITED, Kowloon (HK)

(21) Appl. No.: 14/484,040

(22) Filed: Sep. 11, 2014

(51) Int. Cl. H02J 7/00

(52) U.S. Cl. CPC H02J 7/0044; H02J 7/007

(57) ABSTRACT

A portable power source and control device for a smart phone or tablet is releasably attachable to a user's key ring or key chain and sized to be carried in a pocket or purse. The device has an internal rechargeable battery to provide emergency power for operating the user's phone, USB connectors for connection a power source and the phone, an internal microcontroller, and a Bluetooth® wireless communicator. A user actuator generated a locator command causes the phone to ring to indicate its location; and a locator command from the phone causes the device to emit a sound to indicate the device's location. The device can determine and indicate via LEDs the charge level of the battery, and has flash memory for data storage and transfer between devices.

### BACKGROUND

This invention relates generally to portable battery power devices for mobile devices, and more particularly to a portable multi-functional device for back-up power and recharging the internal battery of a mobile phone or other similar electronic device, for remotely controlling the mobile phone, and for communicating with the mobile phone for locator, data synchronization and other operations.

Today, most people carry and rely upon mobile telephones or other similar electronic devices for communications and information while they are on the go, and to many mobile phones have become as essential as their keys. While mobile phones are convenient and for many are a necessity, they operate on an internal battery that must be recharged frequently. This is particularly true of the so-called “smart phones” which are essentially small portable computers that drain their internal battery quickly. When the battery runs out, the phone cannot be used until the battery is recharged. Phone chargers and spare batteries are bulky and inconvenient to carry, and many people either forget them or simply do not carry them. When the battery is drained, which typically occurs when the phone is most needed, finding some place to recharge it which is often a problem.

Another problem with mobile phones is that they are often misplaced. While one may dial the telephone number of the phone to ring the phone to locate it, this requires access to another telephone in the vicinity of where the phone was misplaced in order to hear the phone ring. Sometimes, there is not another available telephone in the vicinity. There is a related problem with respect to keys which also are frequently misplaced. Keys, however, do not have ringers, and are therefore more difficult to locate.

It is desirable to provide devices and methods to address the foregoing and other problems and inconveniences associated with mobile phones, and it is to these ends that the present invention is directed.

### SUMMARY OF THE INVENTION

The invention addresses the foregoing and other problems by providing, in one aspect, a small portable power and control device containing a rechargeable battery that can be conveniently carried and connected to a mobile phone when the internal phone battery runs out to recharge the phone battery and provide an emergency supply of power to keep the phone operating for a period of time until its internal battery can be fully recharged. In a preferred form, the portable device is attachable to a key ring or keychain so it may be carried with the keys of the phone user, and it may include a USB or other connector that enables the device to be connected to a computer or USB power source to recharge its internal battery. The device may also have a user activated indicator that shows the level of charge of its rechargeable battery to inform the user when the device battery requires recharging.

In another aspect, the power and control device is preferably provided with an internal microcontroller and other circuitry so that it may interface either wirelessly via Bluetooth® or directly via a cable with a cooperating mobile smart phone application (“app”) to perform a number of different functions. These functions may include a locator function that permits the device to activate the phone ringer or other audible emitter on the phone so that a misplaced phone may be located. The phone app may likewise include a locator function that identifies the previous location of the keys, as by using GPS, so that misplaced keys may be located.

In further aspects, the power and control device may cooperate with the phone app to remotely control phone functions, such as the phone ringer or its camera, or to remotely control external devices such as music players and the like via the phone app. The device may additionally contain flash memory for data storage, transfer and synchronization with the phone or a computer, and may enable encrypting the data in the flash memory so that the data is secure.

### BRIEF DESCRIPTION OF THE DRAWINGS

FIG. 1 is a perspective view of a preferred embodiment of a mobile phone power and control device in accordance with the invention that is releasably attachable to a key ring or keychain, the device being shown connected to a mobile smart phone;

FIG. 2 comprising FIGS. 2A-2C are, respectively, a top view, a left side view, and a cut-away top view of the device of FIG. 1;

FIG. 3 is an electrical block diagram of a preferred embodiment of the internal electronics of the device of FIGS. 1 and 2;

FIG. 4 is a functional block diagram illustrating the device and the phone app interfaces for performing commands;

FIG. 5 illustrates the interconnections between the microprocessor and a battery charger of FIG. 3;

FIG. 6 illustrates the operations of the device microprocessor for controlling the device power regulators;

FIG. 7 is a functional block diagram illustrating a process for my device to detect and indicate the charge on the device battery;

FIG. 8 is a functional block diagram illustrating operations performed by the device microprocessor in response to phone commands; and

FIG. 9 is a functional block diagram illustrating the operation of the phone app to send commands the mobile device;

### DESCRIPTION OF PREFERRED EMBODIMENTS

The power and control device of the invention is particularly well adapted for use with mobile electronic devices such as smart mobile phones, tablets and the like, and will be described in that context. It will be appreciated, however, that this is illustrative of only one utility of the invention, and that a power and control device in accordance with the invention has other applicability more generally in connection with other types of portable electronic devices. As used herein, the term “mobile phone” will be used to refer not only to mobile telephones, but also to other portable electronic and computing devices such as tablets.

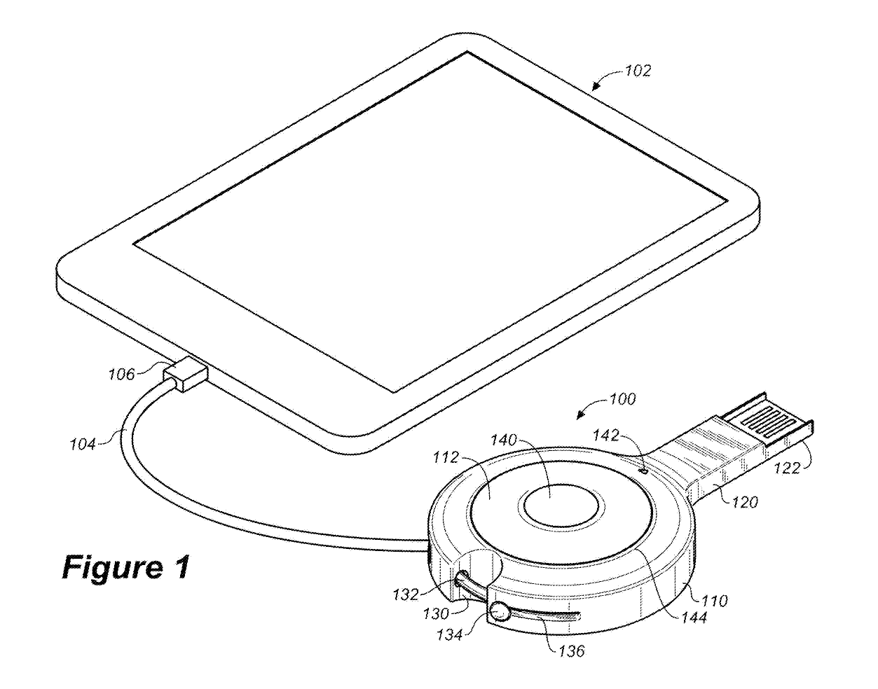

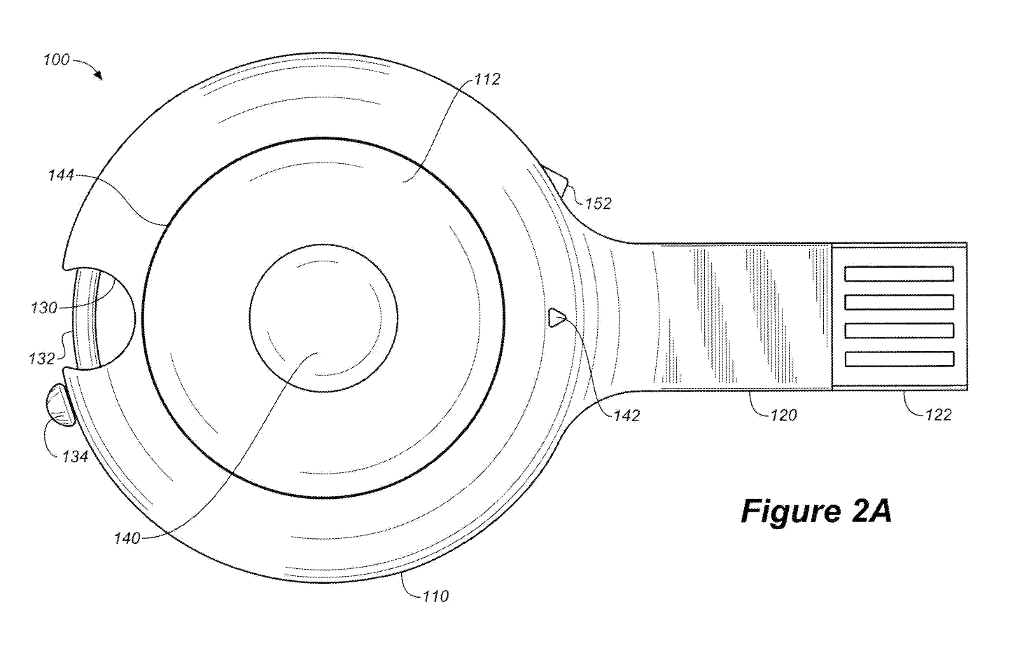

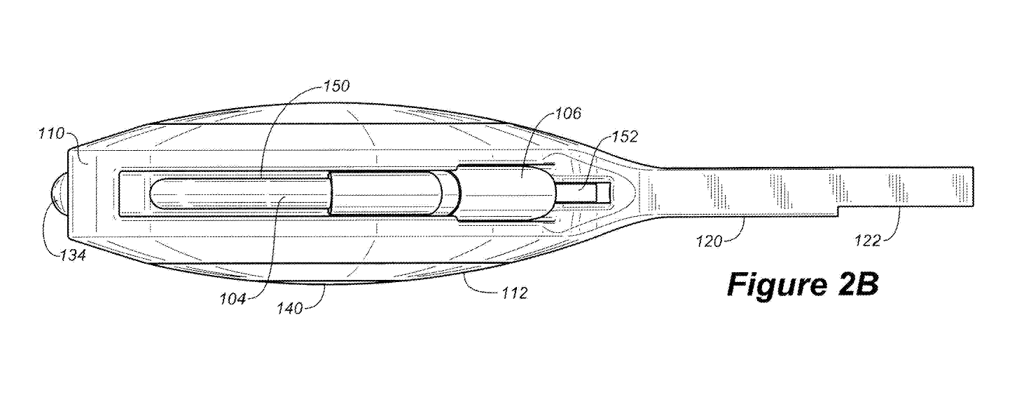

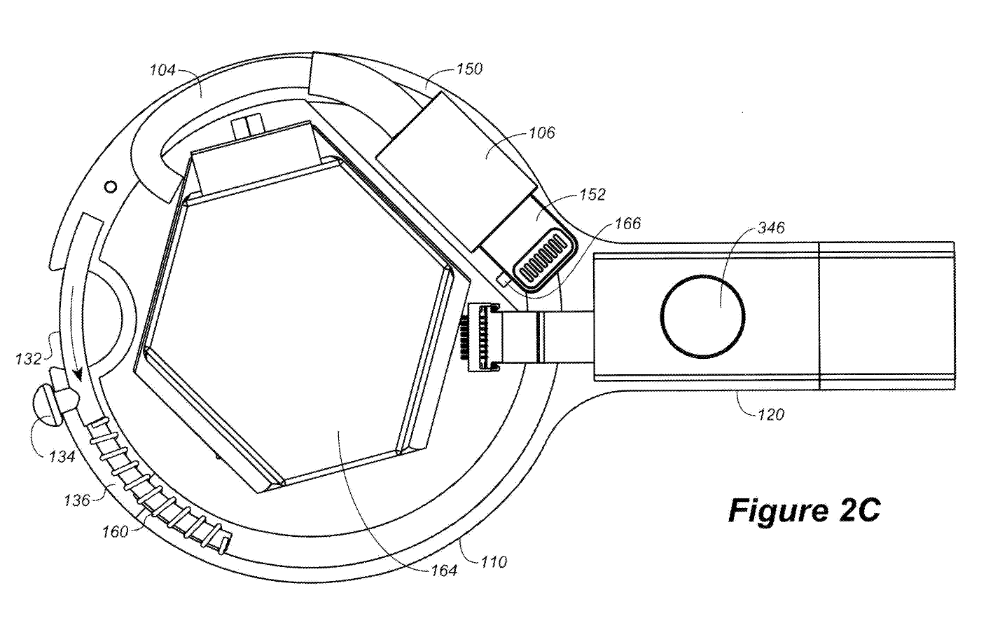

FIG. 1 is a perspective view illustrating a power and control device 100 in accordance with a preferred embodiment of the invention connected to a smart phone 102 by a cable 104 having a connector 106 adapted to interface with the smart phone. Cable 104 and connector 106 may comprise an electrical bus for transferring operating power to the phone and transferring data between the device and the phone, as will be described. FIG. 2A is a top plan view of the power and control device 100, FIG. 2B is a left side view of the device, and FIG. 2C is a cut away top view of the device with the top cover removed to show portions of the interior of the device housing. The device 100 may comprise a short generally cylindrical housing 110 having a convex or dome-shaped upper surface 112 and a similarly shaped lower surface 114 imparting to the housing a generally double dome-shaped configuration that is mirrored about a horizontal plane through the center of the cylindrical housing, as best shown in FIG. 2B. Projecting laterally outwardly from one side of the cylindrical housing is a generally rectangular projection 120 that includes a USB connector 122 at its outer end. As will be described in more detail shortly, the USB connector is adapted to interface with a computer or the like for receiving power from the computer or a power source to charge a rechargeable backup battery within the housing and for communicating data between the computer and electrical circuitry within the device. As will also be described in more detail, the device 100 may supply (via the cable 104 extending from the left side of the housing that connects via connector 106 to the smart phone 102) battery power from the backup battery within the device housing to power and recharge a drained internal battery of the smart phone so the phone can continue operating for a period of time until its battery can be recharged. As will be further described below, the power and control device 100 may additionally communicate bidirectional data and control signals wirelessly and via cable 104 between the smart phone and the electronics within the device housing. The control signals enable control of operations within the device by the smart phone and control of operations of the phone by the device. The control signals also enable the device to remotely control other external devices, such as music players, etc., via the smart phone app.

As further illustrated in FIGS. 1 and 2A, housing 110 may have a semi-spherically shaped cavity 130 with a user controllable releasable latching mechanism comprising a curved (to match the curvature of the housing) slideable latch 132 controlled by a knob 134 extending across the cavity 130. Latch 132 may slide within a slot 136 within the housing 110 to open and provide access to the cavity for receiving a key ring, keychain or the like, and may be spring loaded by a spring 160 in the slot to bias the latch to a closed position, as shown in FIG. 2C. Upon being closed, the sliding latch may capture and retain the user's key ring within the cavity to connect and attach the power and control device to the key ring. Since most people including mobile phone users almost always carry keys, the invention enables mobile phone users to conveniently carry a backup battery power source with their keys to provide power for their mobile phone when the phone battery goes dead. The top of the dome-shaped housing may have a centrally located user actuated pushbutton 140 and a small triangularly shaped multicolor LED 142, for purposes to be described. There may also be a ring of LEDs 144 located in the domed top 112 of the housing. Cable 104 and connector 106 may be contained within a circumferentially extending slot 150 formed in one side of the housing 110, as best shown in FIGS. 2B-2C, when they are not connected to the phone 102. There may be a small magnet 166 within the slot 150 adjacent to the location of the metal tip 152 of connector 106, as shown in FIG. 2C, to retain the connector and cable within the slot when not in use. The interior of the housing has space 164 to accommodate the internal battery and associated electronics, as will be described.

The power and control device 100 may have any convenient size, shape and dimensions. Preferably, it is small enough to conveniently and comfortably fit within a user's pocket or purse attached to the user's key ring. Aesthetically, in a preferred embodiment the device has certain proportions. The ratio of the diameter of the ring 144 in the top surface to the diameter of the cavity 130 is preferably of the order of 11:3. The cavity 130 is preferably semi-spherically shaped. If the sides of the triangularly shaped LED 142 were extended, they would preferably meet the diameter of the ring 144. The distance between the center of the latch member 132 and the top of the triangular LED 142 is preferably equal to the sum of the diameters of the cavity 130 and the ring 144, and the overall length of the device from the latch to the USB connector is preferably 1.414 times the diameter of ring 144. Other proportions as well as other configurations may, of course, be used.

In order to serve as an emergency source of power for a mobile phone, a power and control device in accordance with the invention has an internal rechargeable battery that may be recharged by connecting the device to the USB port of a computer or to a USB power adapter. As will be described, the device may also have internal electronic circuitry to control the recharging of the internal battery (as well as for performing other operations, which will also be described), and enable the state of the internal battery charge to be determined and indicated to a user by multicolor LEDs 142 so that the user may recharge the battery as needed. When emergency backup power is required to power a mobile phone whose battery that has been drained, the phone can be connected to the device using cable 104 and connector 106 to power the phone and recharge the battery from the internal battery of the device. For use with Android and Windows phones and tablets, connector 106 may be a mini USB connector. For use with Apple phones and tablets, connector 106 may be a Lightning connector. Because the device is formed to be releasably attached to the user's key ring and carried with the user's keys, the user will always have backup phone power available when it is needed.

In addition to providing backup power, the device may also cooperate with the mobile phone to perform other functions and operations. One of these functions is a locator function. Since it is very common to misplace one's mobile phone, the power and control device may be used to actuate wirelessly an audible sound of the mobile phone, such as its ringer, to enable the phone to be located. It is similarly common for one to misplace one's keys. Thus, the device may also include an audible device, such as a speaker, that can be wirelessly actuated using an app on the phone to emit an audible sound to enable the keys to be located. Wireless communications between the device and the phone may be via Bluetooth®, which allows the phone and device to communicate at a distance of the order of a hundred feet. Preferred implementations of the locator and other functions that may be performed by the device will be described more below.

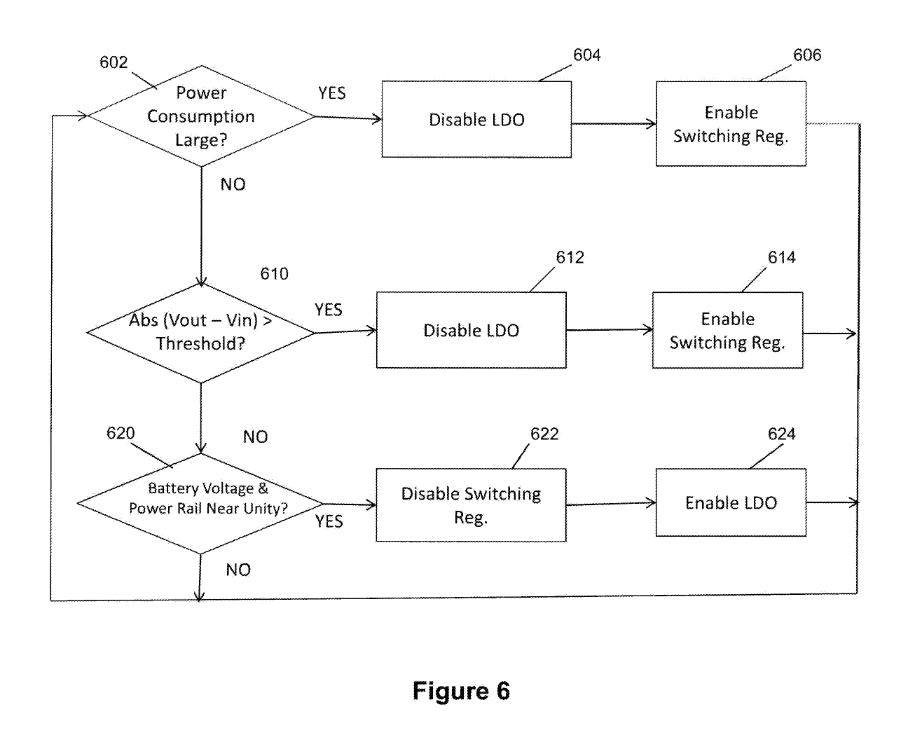

FIG. 3 is a top-level functional block diagram illustrating a preferred embodiment of the electronics within a power and control device in accordance with the invention. As shown, central to the internal electronics of the device may be a microcontroller 302 for controlling the overall operation of the device. Microcontroller 302 may be a Broadcom Corporation BCM20736 integrated circuit system-on-a chip (SoC) comprising a low power consumption, low energy integrated microprocessor and Bluetooth® wireless (BLE) circuit, a crystal controlled clock (XTAL) and an antenna. The chip also includes memory (firmware) embodying executable instructions and data for controlling the microcontroller to perform operations in accordance with the invention, as described herein. A USB port 310 may be connected to USB connector 122 of the device for receiving power from a USB power source, such as a computer, and for supplying the power to a battery charger 312 for charging a rechargeable battery 314. Battery 314 may be a lithium-polymer battery supplying about 400 mAh, which is sufficient to power a mobile phone for an hour or two until it can be recharged. The battery also supplies power through the battery charger 312 to a low drop out (LDO) low current regulator 322 and to a switching power regulator 322 which supply power at, e.g., 2.0V, to power the electronics of the device, and supply power to a USB port controller 324. The LDO has an efficiency which is a function of the ratio of output voltage to the battery input voltage (Vₒᵤₜ/Vᵢₙ). When the ratio is close to unity, the LDO is most efficient and it is more efficient to use the LDO to power the device, particularly at low current. The switching regulator is more efficient at higher currents and when there is a larger difference between Vₒᵤₜ and Vᵢₙ. The microcontroller may implement a process (shown in FIG. 6 and explained below) to determine which regulator to use to power the device at any particular time. Power is supplied from the battery charger 312 to the mobile phone 102 via the USB port controller 324 and a USB phone port 328 which connects to cable 104. The microcontroller 302 may monitor the USB port controller 324 via a bus line 330, and control the port controller via another bus line 332.

The device electronics may also include an LED controller 340 for controlling the RGB multicolor LED 142 on the top of the device to indicate a charging operation and the charge level of the internal battery 314, and control discrete LEDs 342 located, e.g., in or below ring 144 on the top surface of the device so as to be visible when illuminated. The discrete LEDs may be used, for instance, to indicate power flow into the device from USB port 310 for recharging the internal backup battery 314 and/or for powering the phone via the USB phone port 328. The power and control device 100 may receive external power via USB port 310 for simultaneously recharging the device internal battery 314 and for supplying power to the phone via the USB phone port 328. The device may additionally include an accelerometer 344 which detects and characterizes forces exerted on the device. The accelerometer may detect a user shaking the device to initiate a process performed by the microcontroller 302 for determining the backup battery 314 charge level (as will be described) and for activating the RGB LED 142 to indicate the charge level to the user. The accelerometer may also be used to detect other user gestures as commands for other purposes, as will be described.

The microcontroller 302 may also receive an input command from, for example, pushbutton 140 on the top of the device to perform an operation, such as the previously described phone locator operation. In response to input commands, the microcontroller 302 may activate its embedded Bluetooth® Low Energy (BLE) circuit to transmit wirelessly certain codes as predetermined combinations or sequences of tones to the phone. These tones may be received by a Bluetooth receiver in the phone, decoded, and used to initiate prescribed actions. Different input commands to the microcontroller may comprise, for example, different numbers of actuations of the pushbutton 140 within a particular time period. The device may additionally include a speaker 346 controlled by the microcontroller to provide an audible indication to a user.

Other functions that the device 100 may perform relate to data storage, data synchronization and data communications. Accordingly, the device electronics may include non-volatile memory 350, such as NAND flash memory, and a flash memory controller 352 that are under the control of the microprocessor 302. Data may be communicated between the device memory 350 and an external computer via the USB port 310, and between the memory and the phone via the USB phone port 328. Conveniently, the flash memory may also be used to transfer data between the user's smart phone and the user's tablet or another data source. The USB port 310 may be connected to a USB hub 360 by a bidirectional bus 358. The USB hub 360 may be connected by a bidirectional bus 362 to a first USB multiplexer (Mux) 364 which in turn is connected to the flash controller 352 and to memory 350. A second USB Mux 368 may have a bidirectional bus 370 connected to the phone USB phone port 328, and may also connected to memory 350 via the flash controller 352. USB multiplexers 364 and 368 may be likewise connected together via a bidirectional bus 372. This arrangement enables data to be communicated bidirectionally between the USB port 310 and the memory 350, and between the memory and the USB phone port 328. The two USB multiplexers 364 and 368 allow data communications to be switched between the memory and the two USB ports. The memory 350 enables the device 100 to store and transfer data between devices connected to the USB ports, and the microcontroller allows the microcontroller to perform operations on the data, as for encryption and data synchronization.

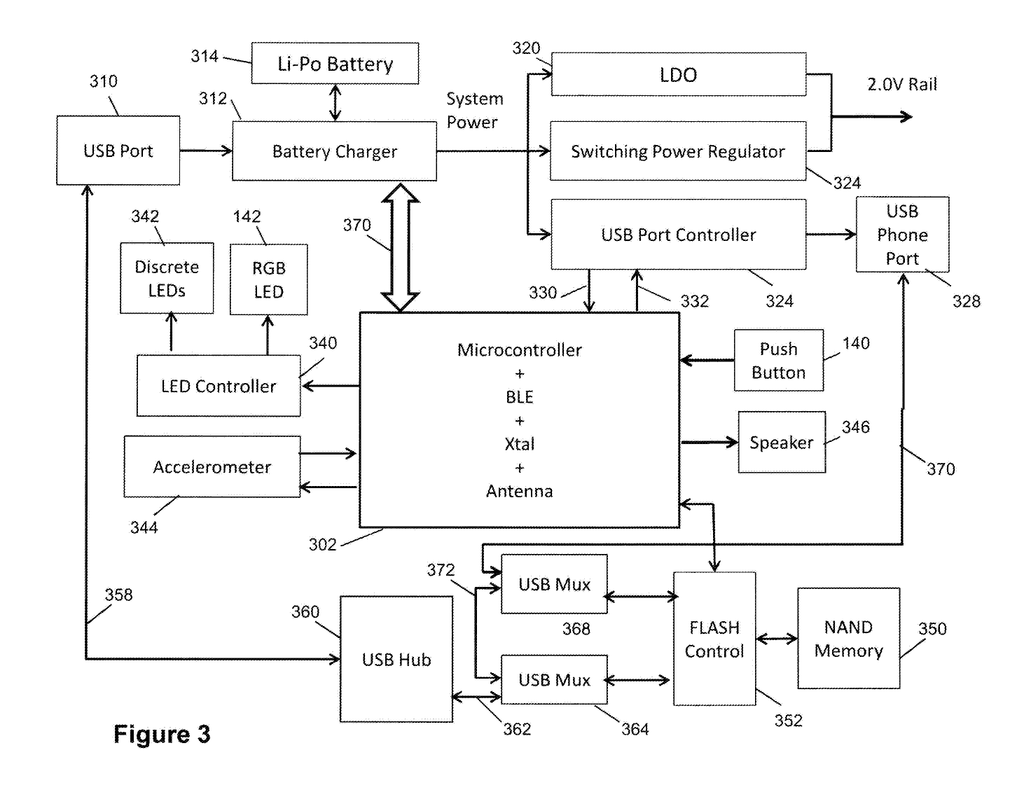

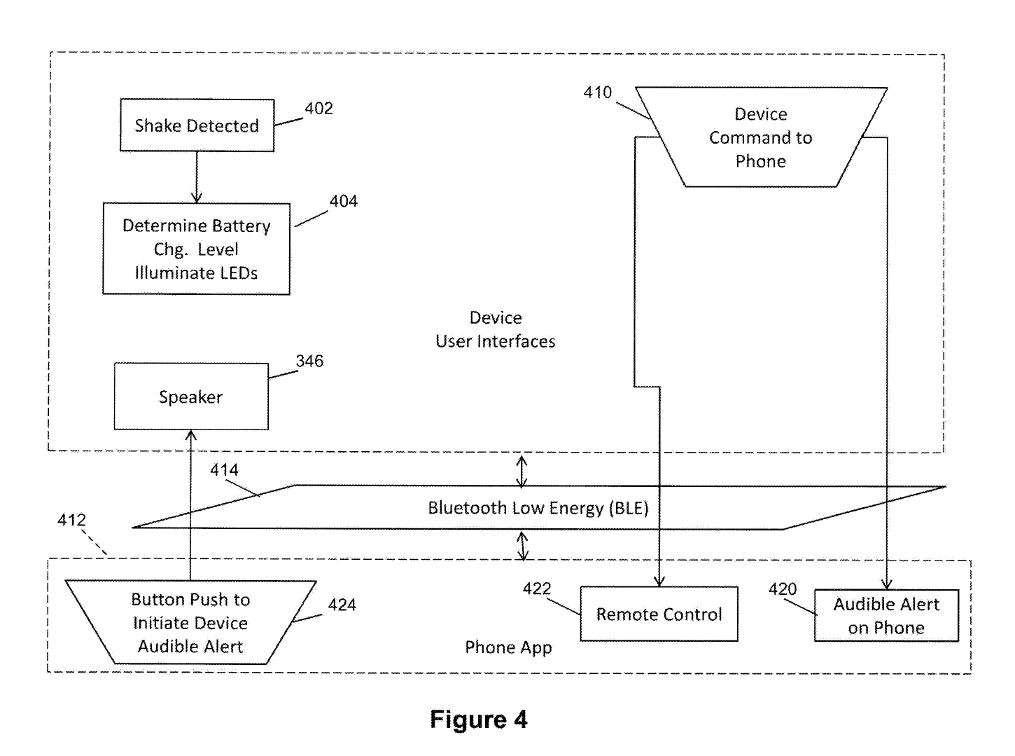

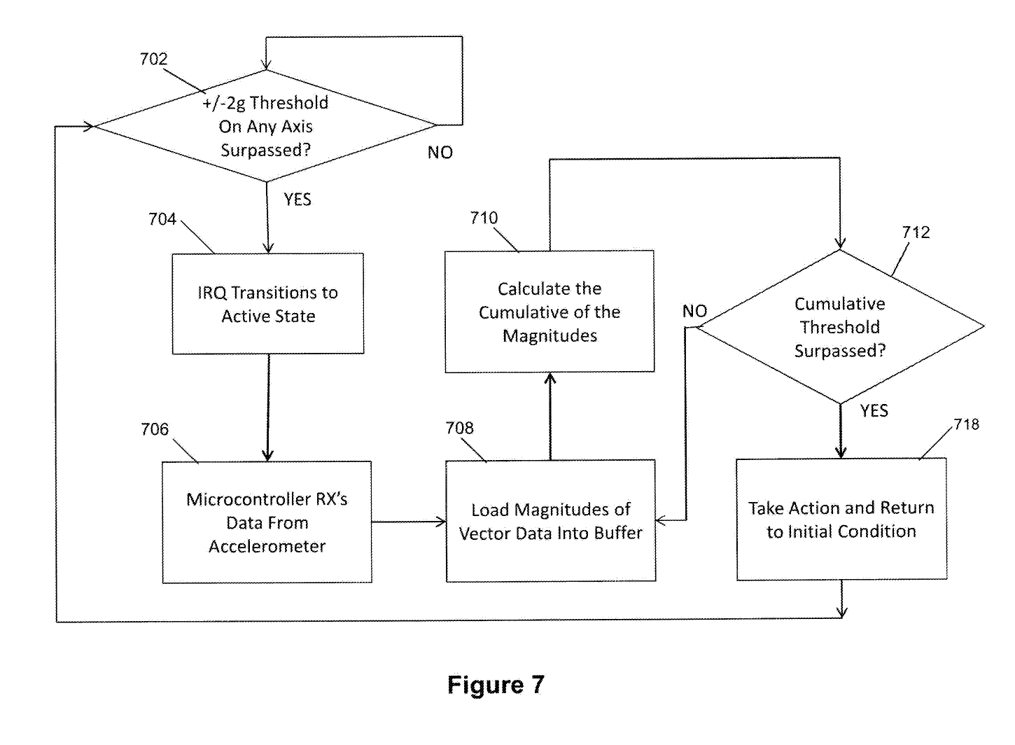

FIG. 4 illustrates user interfaces and processes in embodiments of a device and a phone app for performing operations in accordance with the invention. User interfaces in the device 100 may include a shake and gesture detector utilizing the accelerometer 344 for detecting and measuring the forces and movement exerted on the device by a user. One use of these is for checking and indicating the charge level of the internal backup battery 314. Upon the user shaking or moving the device in a gesture (such as in a predetermined direction for a certain time), the device movement will detected at 402 using the accelerometer 344 to activate a process performed by the microcontroller to decode the movement, as will be described in connection with FIG. 7, and perform an associated operation, such as determining the charge level of the device battery and indicating the charge level by illuminating one or more of the multicolor RGB LEDs 142, as shown at 404. In a preferred embodiment, when the battery charge level drops below a predetermined level, e.g., 20%, the red LED may be illuminated to indicate the user is time to recharge the internal battery. When the device is connected to and charging a mobile phone, the LEDs may illuminate orange, and when the charging is completed, the LED may illuminate green.

Another user interface on the device is pushbutton 140. The pushbutton may be activated at 410 to send commands to the mobile phone app 412 via the Bluetooth® low energy wireless link 414. The commands may cause the phone app to activate an audible alert on the phone, as shown at 424, for the previously described phone locator function. The pushbutton may also send commands to the phone app at 422 to remotely control the phone to perform to perform various operations such as, for example, controlling the phone camera. Additionally, the commands 410 received by the phone app may also cause the phone to remotely control external devices, such as a music player. Similarly, the phone app 412 may include a pushbutton operation 424 that sends a command to the device via the Bluetooth® wireless link to remotely activate the device speaker 346 to perform the previously described keys locator function. As may be appreciated, the controllable functions that may be performed on the device and on the phone will be determined by the design of the phone app and the firmware within the device.

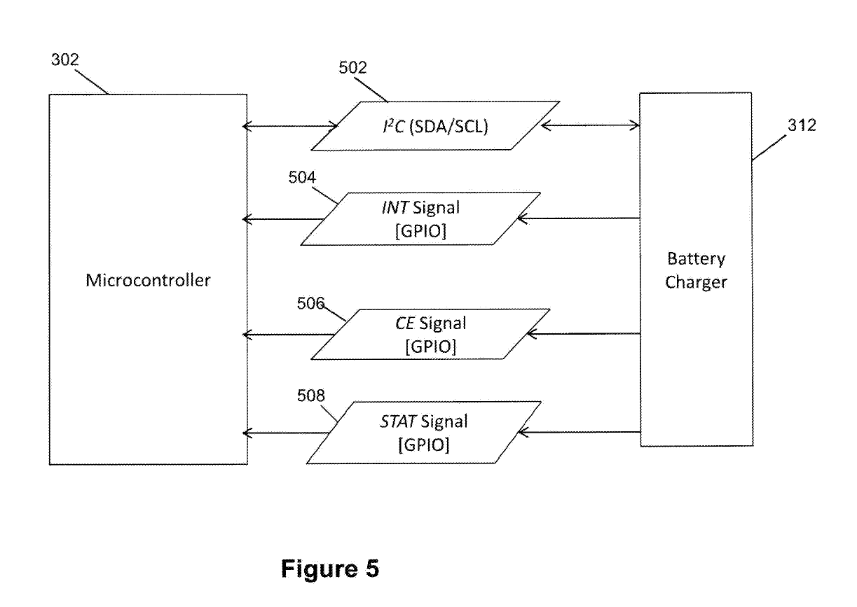

FIG. 5 illustrates the interfaces and the signals exchanged between the microcontroller 302 and the battery charger 312. The battery charger may perform several different functions. As indicated in FIG. 3, the microcontroller and the battery charger to be connected by a bus 370 over which data and control signals are exchanged. As shown in FIG. 5, the microcontroller and battery charger may be connected by an I²C PC bus 502 over which data (SDA) and clock (SCL) are exchanged. The battery charger 312 may be an integrated circuit chip that not only controls an external charge delivered to the battery from USB port 310, but also measures the battery voltage and the current being supplied to the battery from an external source, and voltage and current supplied from the battery to the USB phone port 328. For this purpose, the battery charger may include voltage and current measuring circuits and an analog-to-digital converter (ADC) to supply the measured data to the microcontroller. As will be described, this data is used not only for determining the charge level of the internal battery, but also for controlling the LDO 320, switching power regulator 322, and the USB port controller 324. The battery charger may supply an interrupt (INT) signal 504 as a general purpose I/O (GPIO) signal to the microcontroller to wake up the microcontroller, a charge enable (CE) GPIO signal 506, and a status (STAT) GPIO signal 508 to indicate the status of a charging process of the battery.

FIG. 6 illustrates a process (algorithm) performed by the microcontroller under control of its embedded firmware instructions to switch between the LBO 320 and the switching regulator 322 based upon voltage and current conditions, in order to maximize efficiency and reduce power consumption within the device. At 602, the microcontroller process may determine whether the power consumption is larger than some predetermined level. If so, it disables the LDO at 604 and enables the switching regulator at 606 so that the switching regulator, which is more efficient for large power consumption, controls the power supplied to the device electronics. If the power consumption is not determined to be larger than the predetermined level at 602, at 610 the process determines whether the absolute value of the difference between the output voltage (Vₒᵤₜ) and the input voltage (Vᵢₙ) exceeds a predetermined threshold. If so, the process disables the LDO at 612 and enables the switching regulator at 614 for efficiency reasons. As previously described, the LDO has a maximum efficiency when the ratio of the output voltage to the input voltage is approximately unity and the current is low (power consumption is low), whereas the switching regulator is more efficient at higher currents for larger differences between the output and input voltages. If the absolute value of the difference between the output and input voltages the start exceeds the predetermined threshold as determined at 610, the process proceeds to step 620, at which the process determines whether the battery voltage and the power rail voltage are approximately the same, in which case it disables switching regulator at 622 and enables the LBO at 624. Otherwise the process repeats.

FIG. 7 illustrates the process performed by the microcontroller to detect and measure the movement of the device 100 using the accelerometer 344 in order to initiate an operation. For purposes of illustration, the process for determining and indicating the battery charge of the internal backup battery by shaking the device will be described. It will be appreciated, however, that other types of movements (gestures) may be detected and used to initiate other operations.

The accelerometer 344 may be a conventional integrated device that measures the vector magnitude of the three-dimensional G forces exerted on the device by it being moved, shaken for instance. To determine and indicate the battery charge level, the user may shake the device, for example. If at 702, the G force on any axis exceeds a predetermined threshold, such as 2 G's, an interrupt (IRQ) will be sent at 704 to the microcontroller to cause it to enter an active state. At 706 the microcontroller receives the G force vector data from the accelerometer, and at 708 loads the magnitudes of the data into a buffer. At 710, the microcontroller may calculate the magnitudes of the vector data stored in the buffer, may determine the corresponding directions (e.g., up, down, right, left), and calculate the accumulated magnitudes as a function of time or duration or both. If the cumulative magnitudes surpass a predetermined threshold at 712, the microcontroller acts at 714 to determine the battery charge level using the current and voltage data provided by the battery charger. It may determine charge level using voltage and current accumulated over a predetermined period of time, and indicate the charge level using the RGB LEDs as described above. The process may then return to the initial condition at 702. The cumulative threshold at 712 may be used as a necessary pre-condition for initiating the process of determining battery charge level to conserve internal battery power. The initial and cumulative threshold conditions discriminate between an actual shaking motion by the user and a momentary G force caused, for example, by dropping the device, and the three-dimensional directional data from the accelerometer may be used to discriminate between a shaking for checking battery charge and some other gesture for initiating another operation.

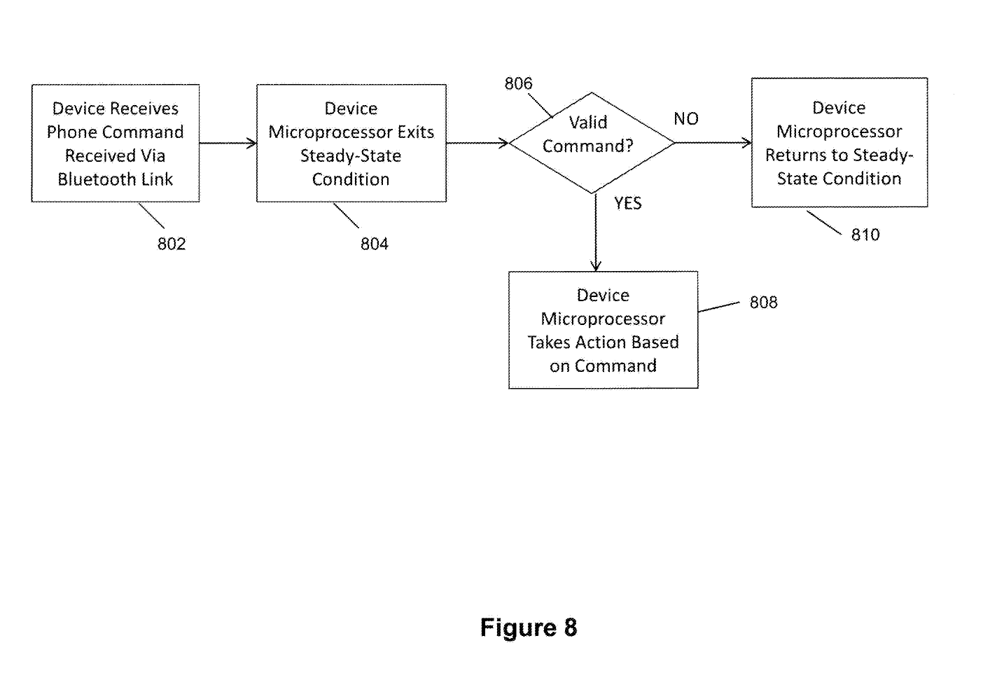

FIG. 8 illustrates a process performed by the microcontroller of the device in response to commands received from the phone. At 802, the device may receive a phone command via the Bluetooth® wireless link. At 804, the microcontroller wakes up and exits a steady-state condition. At 806, the microcontroller in the device decodes the received data and determines whether the command received from the phone is a valid command. If so, the device microcontroller takes the appropriate action at 808 based upon the command. For example, the phone command may be to initiate a locator operation on the device by causing the microcontroller to send tones to the device speaker to emit an audible sound. On the other hand, if the command is determined not to be valid at 806, the device microprocessor returns at 810 to the steady-state condition without acting upon the command.

The invention affords another type of device locator function other than actuating an audible device alarm. Using the phone built-in GPS function, the phone app may remember the last GPS location of the device, which is useful if the device is out of range of the BLE wireless link at the time the locator operation is initiated. This may be accomplished by instructions in the firmware in the device microcontroller causing the device to transmit a periodic “heartbeat” signal (code) via the Bluetooth® wireless link to the phone app. The heartbeat signal may be sent every sent minute or two, for example. Upon receiving the signal, the phone app may determine its current GPS location using its GPS function, and store the current location in phone memory. Each new heartbeat signal may update the GPS location stored in the phone memory. If a user misplaces his or her keys with the device attached, the phone app may read the last GPS location stored in the memory and show that location on a map on the phone display. Thus, the user may return to that location and retrieve the device and keys.

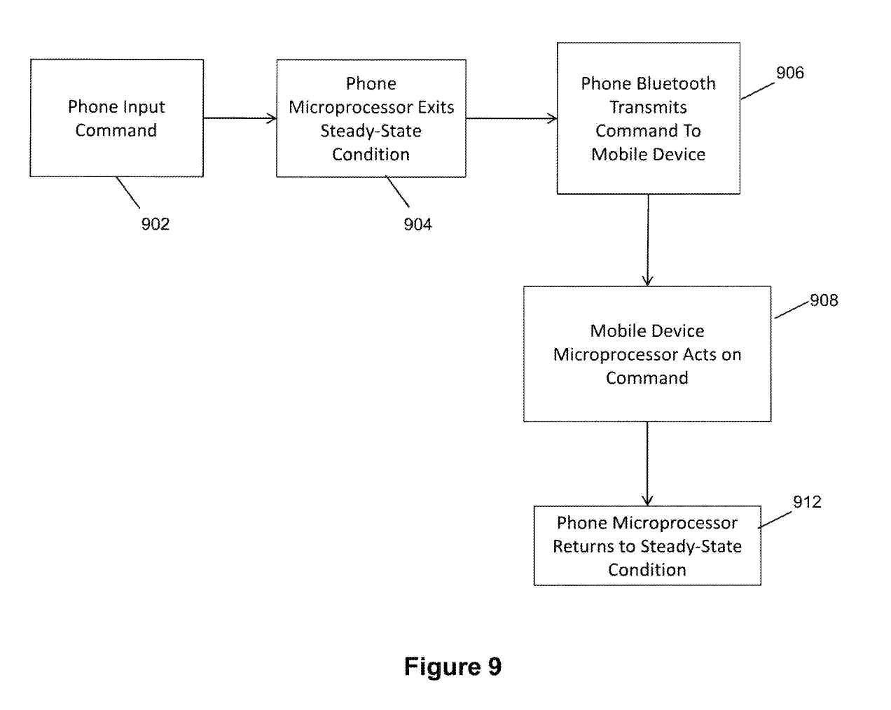

FIG. 9 illustrates a process performed by the phone microprocessor for responding to a user's input command on the phone. As shown, at 902, the phone receives an input command, which causes the phone microprocessor to exit from a steady-state condition. At 906, the phone transmits via the Bluetooth® wireless link an appropriate command to the mobile device in response to the input command received at 902. At 908, the mobile device receives, decodes and acts upon the command from the phone, and at 910 the phone microprocessor returns to a steady-state condition awaiting new input. The command may be to initiate an audible alarm on the device to enable it to be located.

While the foregoing has been with reference to particular embodiments of the invention, it will be appreciated that changes to these embodiments may be made without departing from the invention, the scope of which is determined by the appended claims.

1. A portable mobile phone power and control device comprising:
a housing having a rechargeable battery therein;
a first connector for connection to a power source for recharging said rechargeable battery within the housing;
a second connector for supplying power from said rechargeable battery to a drained internal battery of the mobile phone, the second connector being on a cable that is stored by the housing when the second connector is not connected to the mobile phone; and
a user operable sliding latch within the housing for releasably capturing a key ring of the user within a cutout formed in the housing to attach the device to said key ring.

2. The device of claim 1, wherein said cutout is located in an external surface of the housing and has a semi-spherical configuration, and said sliding latch is movable within an internal slot within the housing and biased by a spring to close an opening of said cutout to capture the key ring therein.

3. The device of claim 1, wherein said housing has a slot located in an external surface thereof, and said cable and second connector are retained in said slot for storage.

4. The device of claim 2 further comprising a magnet positioned within said slot adjacent to location of a metal portion of said second connector when stored to retain the second connector and cable within said slot.

5. The device of claim 1 further comprising electronic circuitry within said housing, said electronic circuitry comprising a battery charger for controlling the recharging of said rechargeable battery, and a microcontroller having executable instructions contained within firmware for controlling the operation of the microcontroller, said microcontroller being operable to determine a charge level of said in rechargeable battery, and for indicating the charge level by an indicator on said housing.

6. The device of claim 5, wherein said electronics circuitry comprises an accelerometer for measuring and characterizing a force exerted on the device by movement caused by a user's gesture, and for actuating said microcontroller in response to a predetermined gesture to determine and indicate said charge level.

7. The device of claim 6, wherein said predetermined gesture comprises a shaking of the device by the user.

8. The device of claim 6, wherein said accelerometer and microprocessor determine magnitudes and directions of forces on the device in three dimensions, and interpret different force characteristics as corresponding to different commands.

9. The device of claim 5, wherein said electronic circuitry further comprises a low drop out regulator for supplying power to said electronics circuitry at low current, and a switching regulator for supplying power at high current.

10. The device of claim 5, wherein said electronics circuitry further comprises a wireless communicator for communicating commands between said device and said mobile phone to perform predetermined operations.

11. The device of claim 10, wherein said commands comprise a first command sent in response to actuation by a user of an actuator on the device to cause said mobile phone to emit an audible signal to indicate a location of the mobile phone.

12. The device of claim 11, wherein said mobile phone has an application responsive to a periodic heartbeat signal sent by the device to cause the mobile phone to update and store its current GPS location, and the application is responsive to a user input command to indicate said stored GPS location on a map on a display of said mobile phone to indicate a last location of the device.

13. The device of claim 1 further comprising non-volatile flash memory within the housing for storing and transferring data between said mobile phone and another data source.

14. A portable mobile phone power and control device comprising:
a housing having a user operable latch for releasably attaching the housing to a key ring of a user;
a rechargeable battery within the housing for supplying power to a mobile phone having a drained battery; and
electronic circuitry within the housing powered by the rechargeable battery; the electronic circuitry comprising a battery charger for controlling the recharging of the rechargeable battery from an external power source and for measuring the voltage of and current from the rechargeable battery; and an accelerometer for measuring forces exerted on the device due to user movements and for providing corresponding signals to a microcontroller; the microcontroller having embedded executable instructions for controlling the microprocessor to detect shaking of the device from said signals, to determine in response to said shaking a charge level of the rechargeable battery using said voltage and current measured by said battery charger, and to control an indicator on the housing to indicate the charge level to the user.

15. The device of claim 14, wherein said electronic circuitry further comprises a wireless communicator for communicating commands between said device and said mobile phone, and a user controlled actuator on said housing for causing said wireless communicator to send a locator command to said mobile phone to emit an audible sound from said mobile phone to indicate a location thereof.

16. The device of claim 15, wherein said microcontroller is responsive to another locator command received from the mobile phone for causing said device to emit an audible sound to indicate the location of the device.

17. The device of claim 14 further comprising flash memory within the device for storing data received from one of a first data source or the mobile phone and for transferring said stored data to a data recipient connected to said device.

18. The device of claim 14, wherein said indicator comprises a multicolor LED, a color of said LED indicating said charge level.
